(19) United States
(12) Patent Application Publication
(10) Pub. No.: US 2026/0263918 A1
(43) Pub. Date: Sep. 10, 2026

(54) EMBEDDED HOSTS AND GAMING SYSTEMS CONTAINING THE SAME

(71) Applicant: Sony Interactive Entertainment Inc., Tokyo (JP)

(72) Inventors: Edwin Foo, San Mateo, CA (US); Nick Dukellis, San Mateo, CA (US)

(21) Appl. No.: 19/073,937

(22) Filed: Mar. 7, 2025

(51) Int. Cl. A63F 13/235; A63F 13/327

(52) U.S. Cl. CPC A63F 13/235; A63F 13/327

(57) ABSTRACT

Methods, systems, and apparatus, including computer programs encoded on computer storage media, for a gaming ecosystem including providing, by a host device and to a first client device including an embedded host wireless communication device in data communication through a first data communication channel, transmission data including (1) a first transmission data to cause operation of the first client device and (2) a second transmission data to cause operation of the embedded host wireless communication device including generating, by the embedded host wireless communication device and responsive to receiving the second transmission data, third transmission data between the embedded host wireless communication device and second client devices in data communication with the embedded host wireless communication device, and providing, by the embedded host wireless communication device and through a second data communication channel, the third transmission data to cause the operation of at least one of the second client devices.

### BACKGROUND

### Technical Field

This specification relates to gaming systems.

### Background

The rapid advancement of gaming technology has led to the development of sophisticated gaming ecosystems including gaming systems, e.g., gaming consoles/personal computers (PCs), and a multiplicity of interconnected peripheral devices that enhance user experience and interactivity. Modern gaming systems often include opportunities to integrate multiple peripherals; for example, virtual reality headsets, motion-sensing controllers, headphones/earbuds, and others that provide immersive gameplay.

### SUMMARY

This specification describes technologies for embedded wireless hosts for a gaming ecosystem. These technologies generally involve a wireless communication device including an antenna embedded within the housing of a peripheral device, e.g., within a form factor of the peripheral device. The embedded wireless communication device is configured to operate as a wireless data communication extension of a host gaming system of the gaming ecosystem for one or more other client devices within a gaming ecosystem. The embedded wireless communication device can be operable to receive and transmit data between the host gaming system to one or more other client devices, where the embedded wireless communication device is configured as a host device to the other peripheral devices.

The embedded host wireless communication device can be in data communication with the host gaming system through a wired data communication channel, where the wired data communication is a shared data communication channel with the peripheral device that includes the embedded wireless communication device within the form factor of the peripheral device. The embedded-host peripheral device including the embedded wireless communication device can be operable to perform the functions of the peripheral device as well as perform the host functions for one or more other client devices. These embedded-host peripheral devices are designed to offer seamless integration, low latency, and high responsiveness, catering to the growing demand for realistic and engaging gaming environments. As the gaming industry continues to evolve, these embedded-host peripheral devices can address the challenges of compatibility, user comfort, and enhanced functionality in a gaming ecosystem including multiple gaming peripherals.

In general, one innovative aspect of the subject matter described in this specification can be embodied in methods including providing, by a host device and to a first client device in data communication with the host device through a first data communication channel, transmission data, the first client device including an embedded host wireless communication device. The transmission data includes (1) a first transmission data to cause operation of the first client device and (2) a second transmission data to cause operation of the embedded host wireless communication device including generating, by the embedded host wireless communication device and responsive to receiving the second transmission data, third transmission data between the embedded host wireless communication device and a plurality of second client devices in data communication with the embedded host wireless communication device, and providing, by the embedded host wireless communication device and through a second data communication channel, the third transmission data to cause the operation of at least one of the plurality of second client devices.

Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. In some implementations, the methods further include receiving, by the embedded host wireless communication device and from at least one of the plurality of second client devices using the second data communication channel, first received data, and providing, by the embedded host wireless communication device and by the first client device and using the first data communication channel, the first received data and second received data from the first client device to the host device.

In some implementations, providing the third transmission data by the embedded host wireless communication device includes providing, by an antenna of the embedded host wireless communication device located within a housing of the first client device, the third transmission data to at least one of the plurality of second client devices. Providing, by the antenna of the embedded host wireless communications device, the third transmission data can include: determining a type of device of a plurality of types of devices for the first client device, determining antenna characteristics for the antenna in response to the type of device of the first client device, and selecting, for the antenna characteristics and the type of device, transmission parameters for the third transmission.

In some implementations, determining antenna characteristics for the antenna in response to the type of device of the first client device includes determining one or more of (i) antenna size, (ii) antenna location and orientation within the housing of the first client device, and (iii) transmission power. Determining a type of device of the plurality of types of device for the first client device can further include determining one or more of (i) relative spatial orientations between the first client device and each of the plurality of second client devices, (ii) level of interference of data transmission between the first client device and each of the plurality of second client devices, and (iii) reliability requirement for data transmission between the first client device and each of the plurality of second client devices.

In some implementations, providing, by the host device and to the first client device in data communication with the host device through the first data communication channel, transmission data includes providing the transmission data using a wired data communication channel.

In some implementations, providing, by the embedded host wireless communication device and to the at least one of the plurality of second client devices through the second data communication channel, the third transmission data includes providing the third transmission data using a wireless data communication channel.

In some implementations, providing, by the host device and to the first client device in data communication with the host device through the first data communication channel, transmission data includes providing the transmission data from the host device including one of a gaming console or gaming personal computer to the first client device including one of a keyboard, monitor, or web camera, wherein the one of keyboard, monitor, or web camera includes the embedded host wireless communications device.

In some implementations, providing the first transmission data to cause operation of the first client device includes providing control signals to cause operation of a native application of the first client device.

In some implementations, providing, by the embedded host wireless communication device and to the at least one of the plurality of second client devices through the second data communication channel, the third transmission data includes providing third transmission data to two or more different second client devices.

In some implementations, providing, by the embedded host wireless communication device and to the at least one of the plurality of second client devices through the second data communication channel, the third transmission data includes providing, the third transmission data to wireless peripheral devices for gaming systems.

In some implementations, a distance of transmission between the embedded host wireless communication device of the first client device and the second client device is less than a distance of transmission between the host device and the second client device.

In general, another innovative aspect of the subject matter described in this specification can be embodied in a system including a host device, a first client device in data communication with the host device through a first data communication channel, the first client device including an embedded host wireless communication device within an enclosure of the first client device, and a plurality of second client devices in data communication with the embedded host wireless communication device of the first client device through a second data communication channel. The host device includes one or more processors in data communication with one or more memory and configured to perform the operations including providing, by the host device and to the first client device through the first data communication channel, transmission data. The transmission data includes (1) a first transmission data to cause operation of the first client device and (2) a second transmission data to cause operation of the embedded host wireless communication device including generating, by the embedded host wireless communication device and responsive to receiving the second transmission data, third transmission data between the embedded host wireless communication device and the plurality of second client devices in data communication with the embedded host wireless communication device, and providing, by the embedded host wireless communication device and through the second data communication channel, the third transmission data to cause the operation of at least one of the plurality of second client devices.

The foregoing and other embodiments can each optionally include one or more of the following features, alone or in combination. In particular, one embodiment includes all the following features in combination. In some implementations, the first client device includes one of a keyboard, mouse, monitor, and web camera device.

In some implementations, the host device includes one of a gaming console and a personal computer.

In some implementations, the embedded host wireless communication device within the enclosure of the first client device includes one or more antenna in data communication with an antenna switch: a radio configured to operate the antenna switch to transmit and receive data through a wireless data communication channel using the one or more antenna, and one or more processors in data communication with one or more memory and in data communication with the radio and configured to perform the operations of providing the third transmission data to cause the operation of at least one of the plurality of second client devices, and receiving, from at least one of the plurality of second client devices, a fourth transmission data.

In general, another innovative aspect of the subject matter described in this specification can be embodied in an embedded host wireless communication device including one or more antenna in data communication with an antenna switch, a radio configured to operate the antenna switch to transmit and receive data through a wireless data communication channel using the one or more antenna, and one or more processors in data communication with one or more memory and in data communication with the radio. The one or more processors configured to perform the operations including receiving, from a host device and to a first client device in data communication with the host device through a wired data communication channel, first transmission data, the first client device including the embedded host wireless communication device within an enclosure of the first client device, wherein the transmission data comprises (1) a first transmission data to cause operation of the first client device and (2) a second transmission data to cause operation of the embedded host wireless communication device including generating, by the one or more processors of the embedded host wireless communication device and responsive to receiving the second transmission data, third transmission data between the embedded host wireless communication device and a plurality of client devices in data communication with the embedded host wireless communication device, and providing, by the one or more processors of the embedded host wireless communication device and through the wireless data communication channel, the third transmission data to cause the operation of at least a second client device of the plurality of client devices.

The foregoing and other embodiments can each optionally include one or more of the following features, alone or in combination. In particular, one embodiment includes all the following features in combination. In some implementations, the first client device includes one of a keyboard, mouse, monitor, and web camera. In some implementations, the host device includes a gaming console or personal computer.

In some implementations, the antenna includes a patch antenna. The antenna can be a directional antenna.

In some implementations, the operation of the embedded host wireless communication device further includes receiving, by the one or more processors of the embedded host wireless communication device and through the wireless data communication channel, fourth transmission data from at least a second client device of the plurality of client devices, and providing, by the one or more processors of the embedded host wireless communication device and through the wired data communication channel, the fourth transmission data to the host device.

In some implementations, a location and orientation of the antenna within the enclosure of the first client device is a first location and orientation for a first type of first client device and a second location and orientation for a second type of first client device. The first type of first client device and the second type of first client device can include one or more of (i) a different form factor of an enclosure of the first client device, (ii) an average distance of the first client device from a user of the first client device, and (iii) an average degree of obstruction of line-of-sight between the user and the first client device. At least one of a size and a radio frequency (RF) power of the antenna within the enclosure of the first client device can be a first size and a first RF power output for a first location of the first client device with respect to a user and a second size and a second RF power output for a second location of the first client device with respect to the user.

The technology described in this specification can be implemented so as to realize one or more of the following advantages. The gaming ecosystem can include a multitude of peripheral devices to which the host device, e.g., gaming console, is in data communication. By embedding a host wireless communication device within a peripheral device, the gaming ecosystem can convert a peripheral into a “host peripheral” to perform the functions of the host, but from a location that is advantageous to communicate with the other peripheral devices in the gaming ecosystem. The host device can leverage a location of the host peripheral with respect to the other peripherals and can use the advantage of a reduced signal interference and improve line-of-sight accessibility between the host peripheral and the other peripheral devices to achieve an improved (e.g., highest-quality) data communication link to wireless peripherals in the gaming ecosystem compared to the other available links.

In some implementations, the host peripheral device is a peripheral having a general location of usage in close proximity to a user and other wireless peripheral devices in a gaming environment. As such, the wireless communication channel between the host peripheral device and other peripheral devices can have low interference from obstructions or other interfering signals.

In some instances, the embedded host wireless communication device is incorporated into a form factor of a low-cost wireless peripheral device, lowering a barrier to integration of the technology.

By understanding the relative orientations of the peripheral devices with respect to the host peripheral device including the embedded host wireless communication device, performance parameters of the one or more antennas of the embedded host wireless communication device can be selected to ensure at least a threshold stability of the wireless communication link. For example, size, orientation, power configuration, etc., of the antennas.

In some instances, rather than using a single, built-in wireless adapter, the gaming host device, e.g., gaming console, can select from multiple communication channels through which to communicate with the wireless peripheral devices in the gaming ecosystem. For example, the host device can select to route some of the data communication through the host peripheral device which may be closer to the peripheral device of interest, e.g., closer to the user, and/or may have a less obstructed view of the peripheral device of interest than the host device itself.

Routing a portion of data communication between the host and one or more peripheral devices through an embedded host wireless communication device within a host peripheral device can reduce power requirements for the data transmission by leveraging the decreased distance, reduced physical obstructions, and decreased interference from one or more other wireless data communication channels from the host device. For example, by extending a distance between the embedded host wireless communication device and other Wi-Fi antennas of the host device, e.g., other wireless channels operating in the same GHz bands, the embedded host wireless communication device can experience reduced interference from the other signals and increased reliability of the wireless data communication link to the other peripheral devices.

In some instances, the host device can prioritize data communication traffic through a wired data communication channel to the host peripheral device, such that all downstream peripheral devices are operating at least a threshold performance, e.g., such that the performance of the native operations of the host peripheral device and the performances of the native operations of each other peripheral device are at least a threshold performance.

In some implementations, the role of host/client of a peripheral device is a dynamic role, where the peripheral device can perform the actions of host and/or client depending on a dynamic configuration of the gaming ecosystem. For example, while connected to a PC through a wired USB connection, the keyboard including an embedded wireless data communication device can act as a host. When the wireless connectivity is activated through a user action on a connection switch, the keyboard can switch into a client role.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic of an example operating environment of a gaming ecosystem.

FIG. 2 is a block diagram of an example gaming ecosystem including a host peripheral device.

FIG. 3 is a block diagram of another example gaming ecosystem including a host peripheral device.

FIG. 4A is a flowchart of an example process for data communication in a gaming ecosystem using an embedded wireless communication device.

FIG. 4B is a flowchart of another example process for data communication in a gaming ecosystem using an embedded wireless communication device.

FIG. 5 shows an example of a computing device and associated accessories that can be employed to execute implementations of the present disclosure.

Like reference numbers and designations in the various drawings indicate like elements.

### DETAILED DESCRIPTION

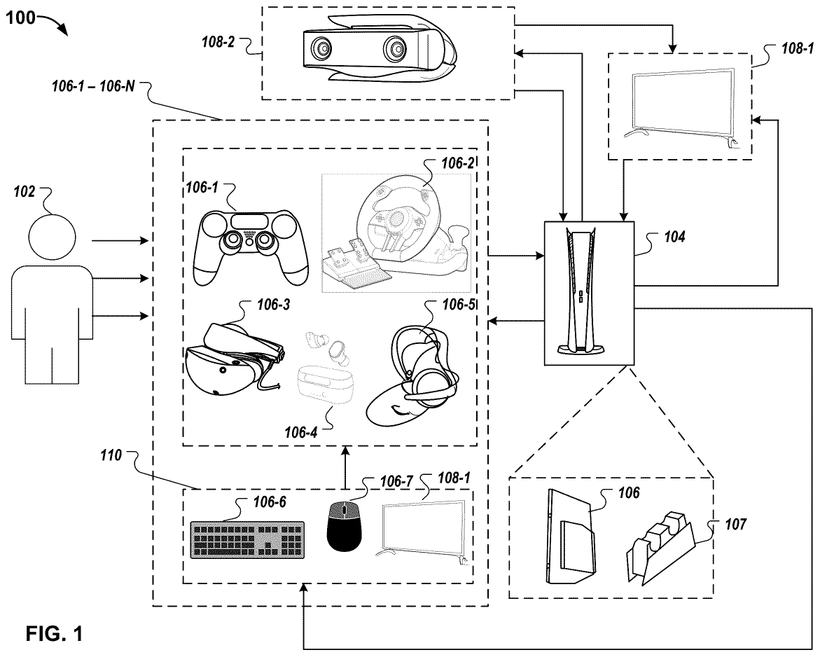

A gaming ecosystem includes a collection of gaming devices which can be used separately or in various combinations in a gaming experience by one or more users. The gaming ecosystem can include one or more gaming systems, e.g., gaming consoles, gaming computers, and one or more peripheral devices. During a game experience, a user may interact with some or all of the gaming devices available in the gaming ecosystem in turn. FIG. 1 is a schematic of an example operating environment of a gaming ecosystem 100.

Gaming ecosystem 100 includes a gaming system 104 through which a user 102, or multiple users, can engage with a gaming experience. Gaming system 104 can be a console, personal computer, or another host device operable to execute a gaming environment, e.g., video game software.

The gaming system 104 includes processors, for example, one or more central processing units (CPU) and one or more graphics processing units (GPU) in data communication with memory and having input/output interfaces configurable to connect to one or more second client devices. Gaming system 104 can be in data communication with one or more servers, e.g., cloud-based servers, through one or more wired or wireless communication networks, such as a cellular communication network, local area network (LAN), wide area network (WAN) such as the Internet, wireless LAN (WLAN), or other type of communication network.

In some implementations, the gaming system 104 includes one or more peripheral components. For example, the gaming system 104 can optionally include an optical disk reader 106. In another example, the gaming system 104 can be a wireless, e.g., handheld, console and includes a wireless charging dock 107.

Gaming ecosystem includes one or more peripheral devices 106-1 to 106-N, where the gaming system 104 can be operable to perform host services for one or more peripheral devices, e.g., also referred to as “client devices.” Peripheral devices can generally be devices which facilitate interaction between a user 102 and the gaming ecosystem 100. Peripheral devices can be configurable to connect through respective data communication channels to the gaming system. The data communication channels can be wired or wireless data communication channels, e.g., also referred to as “wired data communication links” or “wireless data communication links.”

In some implementations, peripheral devices can be configurable to connect to one or more other peripheral devices through respective data communication channels. Wireless data communication channels can be, for example, using Bluetooth, wi-fi, Zigbee, infrared, or another wireless communication protocol.

Peripheral devices 106-1 to 106-N can include, for example, audio peripherals such as speakers, headphones, headsets 106-5, microphones, earbuds 106-4, and the like. Peripheral devices can include, for example, game controllers such as gaming racing wheels 106-2 and pedals, flight simulator controls, joysticks, handheld controllers 106-1, and the like. Peripheral devices can include, for example, computing peripherals such as keyboards 106-6, mice 106-7, and the like. Peripheral devise can include, for example, virtual reality (VR) and augmented reality (AR) components 106-3 such as VR headsets, goggles, handheld controllers, gloves, smart environments, wearable devices, and the like. Peripheral devices can include external data storage, for example, external hard drives, memory cards, memory card readers, and the like. Peripheral devices can include docking stations and/or charging stations, for example, controller docking/charging stations 107, external battery packs, and the like. Peripheral devices can be wireless communication hubs, for example, wireless network hubs, mesh network components, and the like. Peripheral devices can include image and video capture devices 108-2, for example, web cameras, motion capture sensors, and the like. Peripheral devices can include music and rhythm peripherals, for example, interactive musical instruments, microphones, dance interactive components, and the like. Peripheral devices can include hybrid gaming consoles, for example, handheld controllers including display 108-1.

Gaming ecosystem can include one or more displays 108-1. Displays can be, for example, a monitor, television, projector, or otherwise. Display can be in data communication with the gaming system 104 and configured to relay audio/visual information from the gaming system. In some implementations, the gaming system can be in data communication with two or more displays, for example, a monitor and a projected display by a projector onto a screen. Displays can be configured to receive and transmit information through a data communication channel to the gaming system. In some instances, the display is configured to receive input from a user, e.g., through a touch screen, by motion sensor/detector, or the like, and provide input to the gaming system. In some implementations, a display is an integrated component of a gaming system, for example, where the display is an integrated component within a form factor of the gaming system. In some implementations, a display is a peripheral device in data communication with the gaming system through a wired or wireless data communication channel and can have a client/host relationship with the gaming system as part of the gaming ecosystem 100 as described below.

In general, the gaming system 104 is configured to communicate with the peripheral devices in the gaming ecosystem through direct communication through wired or wireless data communication channels. In some instances, a gaming ecosystem can include multiple peripheral devices 106-1 to 106-N transmitting/receiving data with the gaming system during a gaming experience of a user(s), where limitations of wireless data communication channels between the gaming system and one or more peripheral devices can result in degradation of the gaming experience. For example, wireless data communication channels can be affected by distance between transmitter (Tx) and receiver (Rx), obstructions between Tx and Rx, and number of client peripheral devices using the data communication channel to transmit/receive with the host gaming system.

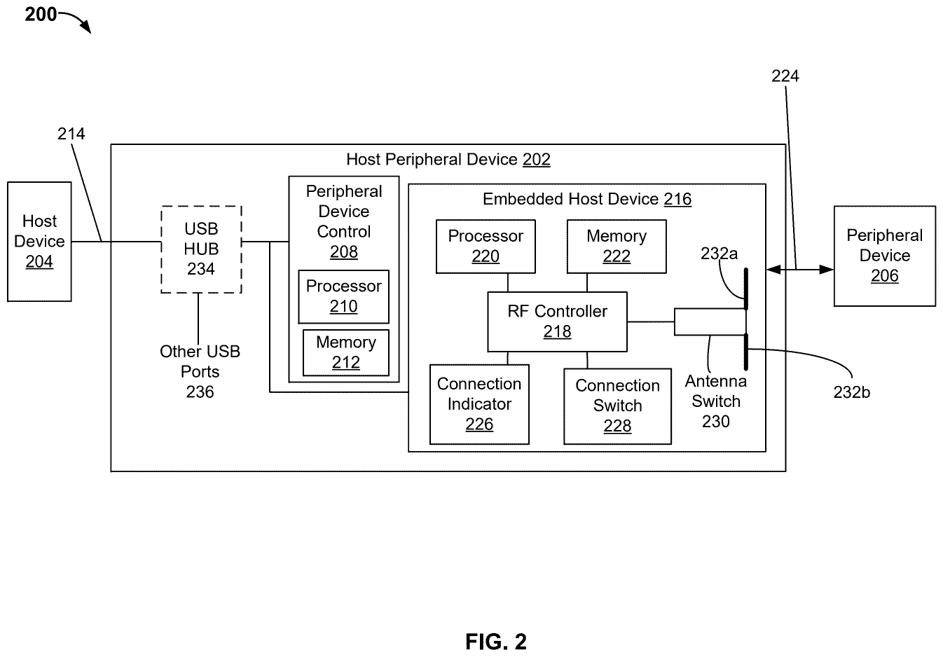

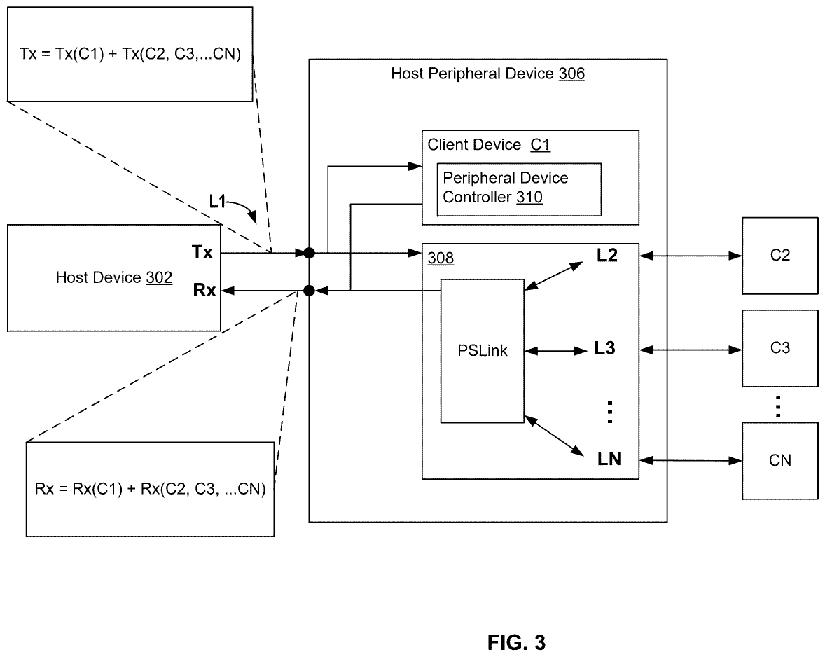

As depicted in FIG. 1, gaming ecosystem 100 includes one or more of the peripheral devices of the gaming ecosystem configured to operate as host devices to one or more other client peripheral devices, e.g., as a “host peripheral device.” The host peripheral device(s) 110 each include an embedded host device, e.g., as described with reference to FIGS. 2 and 3, which functions to allow the host peripheral device 110 to operate as a host to transmit/receive data through a wireless data communication channel to one or more other client peripheral devices.

Although the example of FIG. 1 depicts host peripheral devices 110 as a keyboard, mouse, and display, different peripheral devices can include an embedded host device to perform the operations of a host peripheral device. In some implementations, a gaming ecosystem 100 includes at least one peripheral device that is a host peripheral device. In some implementations, a gaming ecosystem can include two or more peripheral devices including respective embedded host devices which can be operated in tandem or separately to facilitate host/client communication.

Host peripheral devices 110 receive/transmit data through a first data communication channel from the gaming system 104, e.g., gaming console, and receive/transmit data through a second data communication channel to one or more other peripheral devices, e.g., 106-1 to 106-5.

FIG. 2 is a block diagram of an example gaming ecosystem 200 including a host peripheral device 202. The host peripheral device 202, e.g., a peripheral device 110 of FIG. 1, is operable to be in data communication with a host device 204, e.g., gaming system 104 of FIG. 1, through a first data communication channel. The host peripheral device 202 is operable to be in data communication with a second peripheral device 206, e.g., peripheral device 106-1 of FIG. 1, through a second data communication channel.

The host peripheral device 202 includes a peripheral device control 208, which is configured to perform the operations native to the peripheral device. The peripheral device control can include, for example, a processor 210 in data communication with memory 212 and operable to execute the operations native to the peripheral device. The peripheral device control 208 can be in data communication with the host device 204 through a first data communication channel 214.

In some examples, a host peripheral device 202 is a keyboard, where the peripheral device control 208 is operable to perform the native operations of the keyboard. The peripheral device control can be operable to execute the operations of the keyboard for example, receiving input, e.g., detecting and translating key strokes into data, and providing data to the host device. In some examples, a host peripheral device 202 is a monitor display, e.g., display 108-1 of FIG. 1, where the peripheral device control 208 is operable to perform the native operations of the monitor. For example, the display is configured to receive video data from the host device and provide for display the video data on the monitor. In some examples, a host peripheral device 202 is a mouse or another type of game controller, where the peripheral device control 208 is operable to perform the native operations of the mouse or game controller, e.g., detecting and translating movements of the mouse or game controller into data and providing the data to the host device.

The host peripheral device 202 includes an embedded host device 216, also referred to as an “embedded host wireless communications device.” In some implementations, the operations of the embedded host device 216 can be separate from the operations of the peripheral device control 208. For example, the peripheral device control and embedded host device can perform separate functions and can be operated independently of each other.

The embedded host device 216 is embedded within an enclosure, e.g., within a housing, of the host peripheral device 202. For example, for a keyboard, the embedded host device is arranged within a housing of the keyboard, such that a form factor of the keyboard is externally unaltered or minimally altered from a configuration of a keyboard not including the embedded host device. In another example, for a web camera, the embedded host device is arranged within a housing of the web camera such that a form factor of the web camera is externally unaltered or minimally altered from a form factor of the web camera not including the embedded host device.

The embedded host device 216 includes a radio frequency (RF) controller 218 which includes a processor 220 in data communication with a memory 222. The RF controller is configured to receive/transmit data through the first data communication link 214 from the host device 204 and transmit/receive data through a second data communication link 224 to one or more peripheral devices 206.

The RF controller 218 includes a connection indicator 226 operable to provide feedback about a connectivity status of the RF controller of the embedded host device. The connection indicator 226 can be a physical indicator, e.g., a light indicator, or a virtual indicator, e.g., a virtual indicator in an application environment of a user device. For example, an application environment displayed on a monitor in data communication with the host device, e.g., game console, can include a virtual indicator. The RF controller includes a connection switch 228 operable to selectively engage the RF controller 218 of the embedded host device, e.g., to turn on/off the wireless data communication channel of the embedded host device. The RF controller 218 is electrically connected to an antenna switch 230 including at least one antenna. As depicted in FIG. 2, RF antenna switch includes a first antenna 232a and a second antenna 232b. An antenna can be a near-field communication (NFC) antenna designed for short-range communication. For example, coil antennas, dipole antennas, path antennas, or the like. An antenna type can be selected for short-range communication operability. For example, dipole antenna, monopole antennas, path antennas, loop antennas, or the like. An antenna type can depend in part on a frequency of operation, e.g., a frequency band of the data communication. An antenna can be, for example, an omnidirectional antenna, e.g., a patch or microstrip antenna. The antenna can be a directional antenna, e.g., such as a Yagi antenna. Multiple design considerations of the antenna can be selected to yield a wireless data communication channel between the antenna and the one or more other peripheral devices that meets a threshold set of performance requirements, e.g., low latency, low loss, high reliability, and the like. The design considerations can include, for example, size, placement, orientation, and power supply of the antenna. One or more of these design considerations can be optimized to select an antenna type and configuration meeting at least a threshold set of performance requirements.

A type and configuration of the antenna(s) 232a, 232b can depend in part, for example, on requirements of the host peripheral device 202 including the embedded host device 216. For example, type and configuration of antenna can depend in part on form factor of the host peripheral device, a placement of the antenna within the host peripheral device, location of the host peripheral device in the gaming environment, and the like. The type and configuration of the antenna can include directional vs omnidirectional antenna, a size of antenna, a range of broadcast of the antenna, operating power of the antenna, and the like.

In some implementations, type and configuration of an antenna(s) 232a, 232b is selected based in part on a location of the host peripheral device including the antenna(s) with respect to the gaming environment. A location of the host peripheral device 202 within the gaming environment, e.g., with respect to each other gaming device in the gaming ecosystem 200, can dictate a relative distance, e.g., average range of distances, of the antenna to one or more other peripheral devices of the gaming ecosystem and a degree to which the line-of-sight between the antenna and the one or more other peripheral devices of the gaming system is obstructed. For example, a location and orientation of an antenna within the enclosure of the first client device can be a first location and orientation for a first type of first client device and can be a second location and orientation for a second type of first client device.

In some implementations, the one or more other peripheral devices are peripheral devices located in close proximity to the user, e.g., headsets, VR headsets, headphones, wearable devices, and the like. In such cases, the location of the type and configuration of the antenna is selected based in part on a location of the user within the gaming environment. For example, a peripheral device into which the embedded host device is included is selected in part on a relative proximity of the peripheral device to a user of the gaming system and a degree to which the line-of-sight, e.g., within a visual range, between the antenna and the user is obstructed. In some examples, the embedded host device 216 is included in a host peripheral device 202 having close, e.g., less than 1 meter, range of distance from the user of the gaming system, and less than a threshold degree of obstruction, e.g., less than 10%, 5%, 2%, 1% of the signal between the RF antenna and the user is obstructed.

In some implementations, a type and configuration of an antenna is selected in part based on form factor of the retaining peripheral device including the embedded host device. For example, a maximum size of the antenna can be selected in part based on the available space within the form factor of the peripheral device, e.g., a maximum size of an antenna within a mouse can be less than a maximum size of an antenna within a keyboard or monitor.

In some implementations, a type and configuration of an antenna can depend in part on power requirements and available power supply for the antenna. For example, limitations on available power to operate the RF antenna can determine a maximum size of the antenna. In general, further distance and/or increased obstruction of line-of-sight between antenna and the one or more other peripheral devices can require increased power from the antenna in order to maintain a stable, e.g., reliable, wireless data communication channel.

In some implementations, type and configuration of an antenna is selected based on a power requirements for the RF signal to maintain at least a threshold connectivity between the embedded host device and the one or more other peripheral devices. A threshold connectivity can be defined, for example, by connectivity distance range, a target latency, a target resilience of the connectivity, or the like. For example, a target range for connectivity can be 0-3 meters, e.g., that the connection is maintained for a range of separation between host and client of 0-3 meters. In another example, a threshold connectivity can be defined as a latency of the wireless data communication that is within a threshold performance of a wired connection, e.g., where a difference in performance between the wireless connection and a wired connection is indiscernible by a user. In another example, a threshold connectivity can be defined as a resilience of the connection to external aggressors can be within a threshold performance of another type of wireless connectivity protocol, e.g., Bluetooth, from 3-30 meters.

In some implementations, the embedded host device is retained within a form factor of a monitor, e.g., a computer monitor, television, or another type of display in data communication with the host device. The antenna of the embedded host device located within the monitor can be a directional antenna or omnidirectional antenna and oriented to transmit/receive a frustum aligned with the plate of the monitor display. The size of the antenna of the embedded host within the monitor can depend on (i) an average distance of the monitor to the one or more other peripheral devices, e.g., peripheral devices located in close proximity to the user, (ii) an average interference or obstruction of the RF signal from the antenna within the form factor of the monitor to the one or more other peripheral devices, (iii) a size of the power supply available to power the antenna, e.g., a power supply of the monitor, or (iv) a combination of any of these.

In some implementations, the embedded host device is retained within a form factor of a keyboard, e.g., a wired keyboard, in data communication with the host device. The antenna of the embedded host device located within the keyboard can be a directional antenna or omnidirectional antenna and oriented to transmit/receive in an arc perpendicular to a top surface, e.g., surface including the keys, of the keyboard. The size of the antenna of the embedded host within the keyboard can depend on (i) an average distance of the keyboard to the one or more other peripheral devices, e.g., peripheral devices located in close proximity to the user, (ii) an average interference or obstruction of the RF signal from the antenna within the form factor of the keyboard to the one or more other peripheral devices, (iii) a size of the power supply available to power the antenna, e.g., a power supply of the keyboard, or (iv) a combination of any of these.

In some implementations, client device 1 includes a USB hub 234 including a first USB port in data communication with the peripheral device control, a second USB port in data communication with the embedded host device, and one or more additional USB ports 236. The one or more additional USB ports 236 can be configured to connect to one or more additional peripheral devices through respective data communication channels. In some instances, the one or more additional USB ports 236 can be configured to connect to one or more additional peripheral devices through respective wired data communication channels. The USB hub 234 can be configured to transmit/receive data through wired data communication channel from host device and provide/receive the respective data through respective ones of the USB ports to the various connected devices.

In some implementations, the client device including the host embedded device has a dynamic relationship to the gaming ecosystem, depending in part on a configuration of the gaming ecosystem. For example, the client device including the host embedded device can be dynamically configured as host and/or client depending on the needs of the end user of the gaming ecosystem. The client device including the host embedded device can switch between (i) host only, (ii) client only, and (iii) host and client simultaneously depending in part on a status of the other devices, e.g., other host and client devices, of the gaming ecosystem.

In some implementations, a client device including the host embedded device can relay data communication between the host device and multiple client devices, e.g., multiple peripheral devices of the gaming ecosystem. FIG. 3 is a block diagram of an example gaming ecosystem 300 including a host peripheral device 302.

As depicted in FIG. 3, host device 302 includes a data communication channel L1, e.g., a transmission channel (Tx) and a receiving channel (Rx). In some instances, the Tx and Rx channels are implemented through a same wired data communication channel L1. The wired data communication channel L1 can be, for example, an electrical data communication channel, an optical data communication channel, or the like. For example, a wired data communication channel can be implemented through a fiber optic cable. In another example, a wired data communication channel can be implemented through an electrical cable operable to transfer data, e.g., a coaxial cable, a USB-based cable, ethernet cable, Lightning™ cable, Thunderbolt™ cable, HDMI cable, FireWire™ Cable, eSATA cable, RS-232 serial cable, VGA cables, or the like.

The host device 302 can provide transmission data through the wired data communication channel L1 to a host peripheral device 306, e.g., a host peripheral device 202 as described in FIG. 2, which includes an embedded host device 308. The host peripheral device 306 is configured to perform operations as a first client device C1 of the host device 302 as well as configured to perform operations of a host to one or more additional client devices C2, C3, . . . CN.

The transmission data can include first transmission data for the first client device C1, e.g., Tx(C1), and additional transmission data for N additional client devices, e.g., Tx(C2, C3, . . . CN), where N is the number of additional client devices. The first client device C1 receives the transmission data, where the first transmission data Tx(C1) is provided to the controller 310 for the first client device C1 to cause operation of the native functionality of the first client device. The first client device C1 relays, e.g., through a USB hub or by use of a controller, the additional transmission data Tx(C2, C3, . . . CN) to the embedded host device 306. The embedded host device 306 receives the additional transmission data Tx(C2, C3, . . . CN) and transmits, e.g., by the RF controller 218 as described with reference to FIG. 2 and through respective wireless data communication channels L2, L3, . . . LN, the respective transmission data, e.g., Tx(C2), Tx(C3), . . . Tx(CN) to at least one of the additional client devices C2, C3, . . . CN.

The embedded host device 308 can receive, using the RF controller 218 as described with reference to FIG. 2 and through respective wireless data communication channels L2, L3,. . . LN, respective transmission data, e.g., Rx(C2), Rx(C3), . . . Rx(CN) from at least one of the additional client devices C2, C3, . . . CN. The host device 302 can receive, through a wired data communication channel L1 and from the embedded host device 308, the respective transmission data from at least one of the additional client devices, e.g., Rx(C2, C3, . . . CN). In some instances, the host device can receive, through the wired data communication channel L1 and from the first client device C1, the transmission data Rx(C1) from the first client device to the host device.

In some implementations, the host device 302 exchanges data communication with the first client device C1 through the wired communication channel L1 and with the one or more other client devices relayed through respective wireless communication channels L2, L3, . . . LN through the embedded host device 308. At a given time, the host device 302 can exchange data communication with fewer than the total number of client devices present in the gaming ecosystem, e.g., some peripherals may not be on and/or may not be linked to the embedded host device.

In some implementations, the host device 302 exchanges different data communications with each of the first client device C1 and the one or more other client devices C2, C3, . . . CN. For example, the host device can exchange first data communications, e.g., keyboard-related data control Tx(C1) and feedback Rx(C1) with a first client device C1 that is a keyboard, and can exchange second, different data communications, e.g., audio data Tx(C2) and feedback Rx(C2) with a second client device C2 that are ear buds, for example, streamed audio to the ear buds and receive microphone feedback.

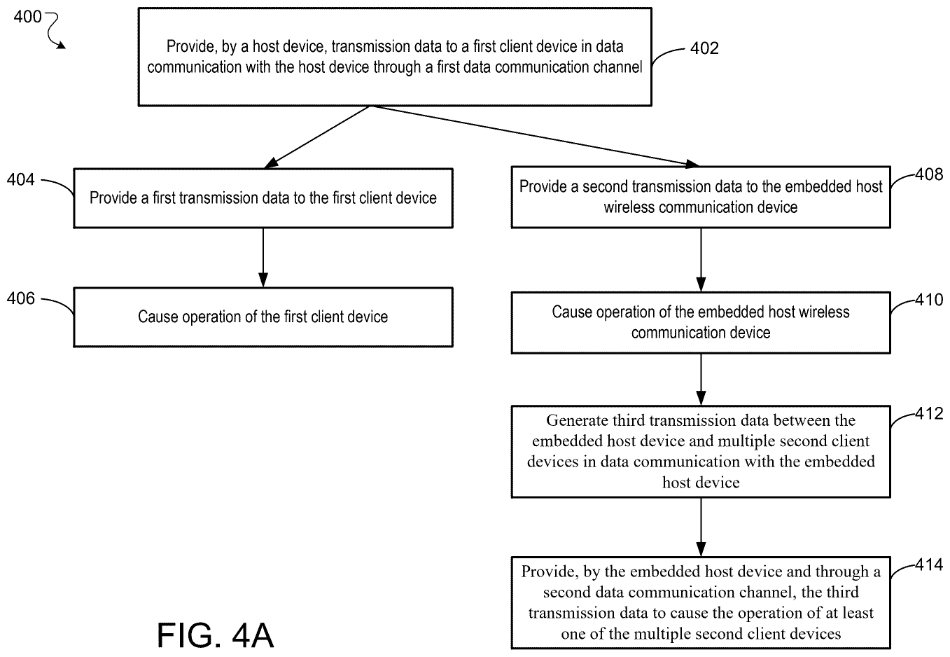

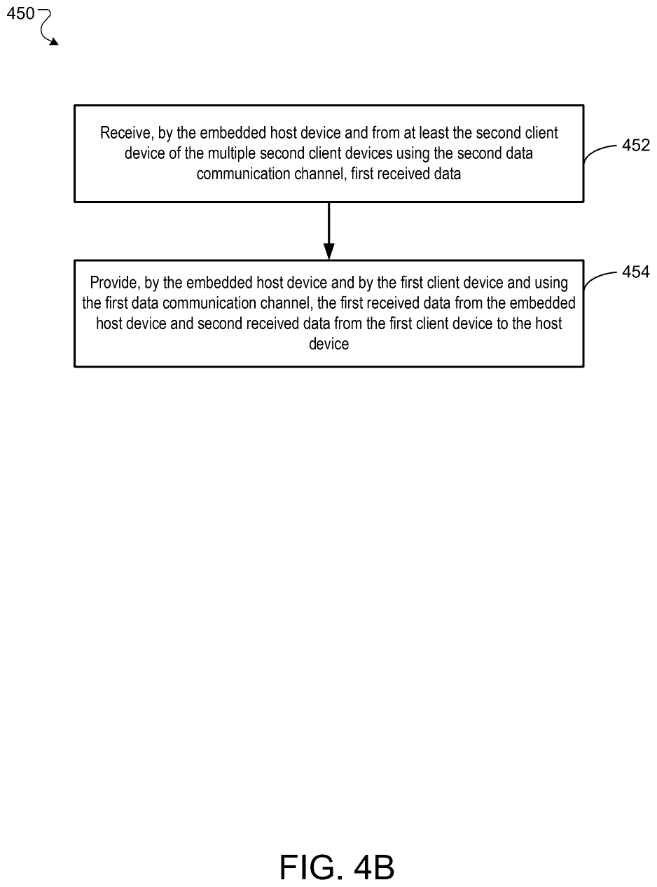

As described with reference to FIGS. 2 and 3, the host device 302 can select to route some of the data communication through the embedded host device 308 within a host peripheral device 306, where the host peripheral device includes an embedded host device 308 within the form factor of the host peripheral device 306. FIG. 4A is a flowchart of an example process 400 for data communication in a gaming ecosystem using an embedded wireless communication device.

A host device provides 402 transmission data to a first client device in data communication with the host device through a first data communication channel, e.g., a wired data communication channel. The first client device, e.g., a first peripheral device, includes an embedded host wireless communication device. Providing the transmission data includes (1) providing 404 a first transmission data to cause 406 operation of the first client device and (2) providing 408 a second transmission data to cause 410 operation of the embedded host device. The second transmission data, when processed by the processor(s) of the embedded host device, cause the embedded host device to perform the operations including: generating 412, by the embedded host device and responsive to receiving the second transmission data, third transmission data between the embedded host device and multiple second client devices in data communication with the embedded host device. The operations further include providing 414, by the embedded host device and through a second data communication channel, e.g., a wireless data communication channel, the third transmission data to cause the operation of at least one of the plurality of client devices.

In some implementations, providing the third transmission data includes providing, by an antenna of the embedded host device within the housing of the first client device, the third transmission data to at least one of the multiple second client devices. For example, the embedded host device can relay, through a wireless data communication channel, the third transmission data to a peripheral device within the gaming ecosystem. The third transmission data can be provided using a set of transmission parameters, where the transmission parameters can depend in part on a type of device of the different types of devices for the first client device including the embedded host device and determining antenna characteristics of the embedded host device. The antenna characteristics can include one or more of antenna size, antenna location and orientation within the housing of the first client device, and transmission power. The type of device can dictate one or more of relative spatial orientations between the first client device and each of the second, receiving client devices, a level of interference of the data communication. In some instances, a reliability requirement of the data communication, e.g., low latency, high fidelity, etc., can dictate the transmission parameters.

In some implementations, the distance of data communication between the embedded host device of the first client and a second client device is less than a distances of data communication between the host device and the second client device. For example, a distance between a keyboard and a headset worn by the user is less than a distance between the gaming console and the headset worn by the user. Additionally, a degree of physical obstruction, e.g., amount of the line-of-sight blocked by other objects, is less between the keyboard and the headset than between the gaming console and the headset.

FIG. 4B is a flowchart of an example process 450 for data communication in a gaming ecosystem using an embedded wireless communication device. The embedded host device receives 452 from at least the second client device of the plurality of client devices using the second data communication channel, first received data. The embedded host device and the first client device provide 454, using the first data communication channel, the first received data from the embedded host device and second received data from the first client device to the host device.

In some implementations, performance parameters of an embedded host wireless communication device are calibrated in response to the type of host peripheral into which the embedded host wireless communication device is embedded. For example, performance parameters include antenna orientation and location of embedded host wireless communication device within the host peripheral which are calibrated based in part on historical data, e.g., data collected for similar peripheral devices operating in similar gaming ecosystems. In another example, performance parameters include antenna orientation and location of embedded host wireless communication device within the host peripheral which are calibrated based in part on models or rules-based understanding of relative placement of peripheral host in the gaming ecosystem, e.g., a keyboard is generally placed directly in front of a user, a mouse is generally offset to the right or left of center of the user.

In some implementations, performance parameters of an embedded host wireless communication device are fine-tuned. For example, performance parameters such as antenna power, sensitivity, and the like, can be fine-tuned based in part on user-specific configuration, e.g., relative placement of peripherals in the gaming ecosystem. The fine-tuning can be used to establish a threshold link connectivity versus power usage for a given configuration of host device and peripheral devices. In some instances, the host gaming system can advise the user on how to physically orient relative positions of peripheral devices and the host device to optimize a threshold link connectivity versus power usage of the gaming ecosystem.

Although described herein with reference to a single host device and multiple peripheral devices, in some implementations, a gaming ecosystem can include multiple, e.g., two or more, host devices and multiple peripheral devices. The described one-to-many relationship can be applied to many-to-many relationships, where each host device can be in data communication through a first, wired data communication link to a host peripheral device, e.g., a same or different host peripheral device as others of the host devices, and communicate with multiple other peripheral deices through a second, wireless data communication link through the embedded host wireless communication device within the host peripheral device.

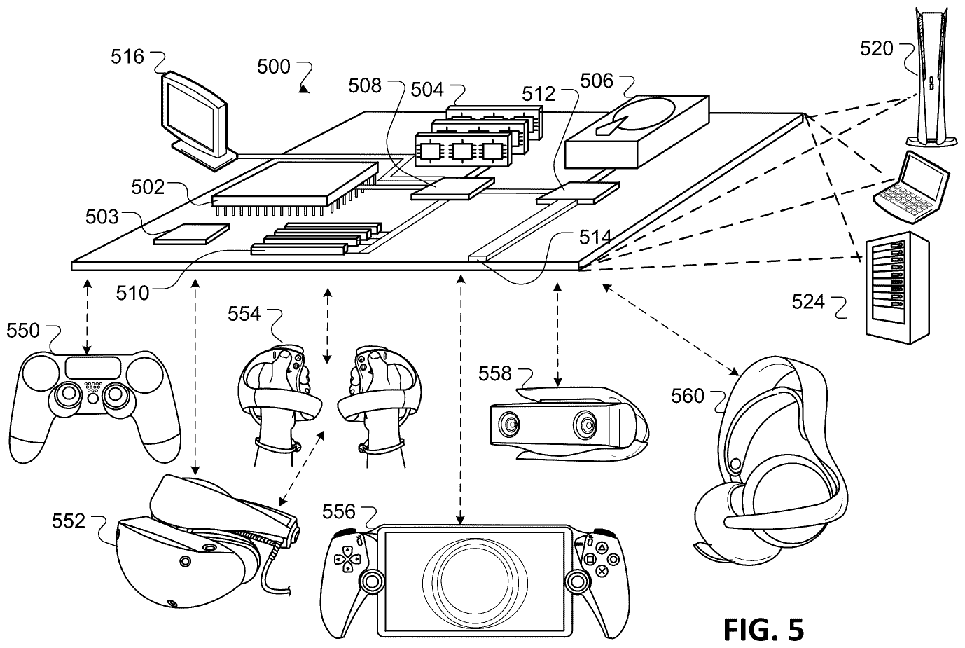

FIG. 5 shows an example of a computing device 500 and associated accessories that can be employed to execute implementations of the present disclosure. The computing device 500 can be a gaming console 520, such as PS5®, PS4®, PS3®, PS2® etc., or as one or more servers 524 or as a rack within a server. In some implementations, the computing device 500 may be implemented as a personal computer such as a laptop computer 522. In some implementations, the computing device 500 can be implemented as a mobile device such as the connected handheld gaming device 556. In some implementations, a computing device can include one or more of the computing device 500, and an entire system may be made up of multiple computing devices communicating with each other. For example, a gaming system can include one or more of a gaming console 520, one or more accessories, and a remote platform such as a cloud-based platform implemented on one or more servers 524. The computing device can also include a desktop computer, a workstation, a personal digital assistant, a server, a blade server, a mainframe, or other appropriate type of computer. The components shown here, their connections and relationships, and their functions, are examples only, and are not limiting.

In various implementations, the computing device 500 includes some combination of one or more processors or central processing units (CPUs) 502, one or more graphic processing units (GPUs) 503, memory 504, one or more storage devices 506, a high-speed interface 508, and/or a low-speed interface 512. In some implementations, the high-speed interface 508 connects to the memory 504 and multiple high-speed expansion ports 510. In certain implementations, the low-speed interface 512 connects to a low-speed expansion port 514 and the storage device 504. In some implementations, the high-speed interface 508 connects to the storage device 504. Each of the processor 502, the GPU 503, the memory 504, the storage device 506, the high-speed interface 508, the high-speed expansion ports 510, and the low-speed interface 512, are interconnected using various buses, and may be mounted on a common motherboard or in other manners as appropriate. The processor 502 can process instructions for execution within the computing device 500, including instructions stored in the memory 504 and/or on the storage device 506 to display graphical information for a graphical user interface (GUI) on an external input/output device, such as a display 516 coupled to the high-speed interface 508. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 504 stores information within the computing device 500. In some implementations, the memory 504 includes a volatile memory unit or units. Alternatively, or in addition, the memory 504 can include a non-volatile memory unit or units. The memory 504 may also include another form of a computer-readable medium, such as a magnetic or optical disk. In some implementations, the memory 504 includes Graphics Double Data Rate (GDDR) memory such as GDDR6 memory configured to provide a unified memory architecture with a high bandwidth. In some implementations, the memory can include high speed memory such as GDDR2, GDDR3, GDDR4, GDDR5, GDDR5X, GDDR6X, GDDR6W or GDDR7. Such high-speed memory can facilitate rapid data access and seamless multitasking, supporting gaming and multimedia applications.

The storage device 506 provides mass storage for the computing device 500. In some implementations, the storage device 506 may be or include a computer-readable medium, such as a hard disk device, an optical disk device, a flash memory, or other similar solid-state memory device, or an array of devices, including devices in a storage area network or other configurations. In some implementations, the storage device 506 can include a high capacity solid-state drive (SSD) configured to support a high throughput (e.g., 5.5 GB/s or more). Such an SSD can facilitate fast load times, enabling near-instantaneous game booting, level transitions, and asset streaming. In some implementations, the storage device 506 can be configured to support expandable storage via compatible non-volatile memory express (NVMe) SSDs. Instructions can be stored in an information carrier, and when executed by one or more processing devices, such as processor 502, perform one or more methods, such as those described above. The instructions can also be stored by one or more storage devices, such as non-transitory computer-readable or machine-readable mediums, such as the memory 504, the storage device 506, or memory on the processor 502. The instructions can constitute software for providing interactive game play on a user interface such as a graphical user interface (GUI) presented on the display 516.

The high-speed interface 508 generally manages bandwidth-intensive operations for the computing device 500, while the low-speed interface 512 generally manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which accepts various expansion cards. In the implementation, the low-speed interface 512 is coupled to the storage device 506 and the low-speed expansion port 514. The low-speed expansion port 514, which may include various communication ports (e.g., Universal Serial Bus (USB) Type-A and Type-C ports, High-Definition Multimedia Interface (HDMI) ports, Bluetooth, Ethernet, wireless Ethernet) may be coupled to one or more input/output and/or accessory devices. Such input/output and accessory devices can include a controller 550 such as a DualSense®, DualShock®, or Access™ controllers for PlayStation® devices, a virtual reality (VR) or augmented reality (AR) headset 552 such as the PS VR2 headset, accessory controllers 554 such as PS VR2 Sense™, a handheld gaming device 556 such as PlayStation Portal®, a camera 558, and/or an earphone/headphone set 560 such as the PULSE Elite™ headset or the Pulse Explore™ earbuds. In some implementations, the computing device 500 includes one or more acoustic transducers, and/or is connected to one or more external acoustic transducers such as one or more speakers associated with the display 516.

The processor 502 can be implemented as a chipset of chips that include separate and multiple analog and digital processors. For example, the processor 502 can be a multi-core processor that supports high-speed processing and enables complex computational tasks, real-time physics simulations, and advanced artificial intelligence (AI) capabilities. In one example, the processor 502 includes at least 8 cores, at least 16 threads, and operates at variable frequencies around 3.5 GHz or more. In some implementations, the processor 502 may be a Complex Instruction Set Computers (CISC) processor, a Reduced Instruction Set Computer (RISC) processor, or a Minimal Instruction Set Computer (MISC) processor.

In some implementations, the GPU 503 includes a custom GPU that supports an advanced architecture such as the RDNA 2 architecture developed by AMD. In certain examples, the GPU 503 includes at least 36 compute units running at speeds of 2 GHz or more and delivers performance of at least 10 teraflops. The GPU 503 can be configured to support high quality graphics rendering. For example, the GPU 503 can be configured to support hardware-accelerated ray tracing for enhanced realism in lighting and reflections, thereby providing a highly immersive gaming experience.

The computing device 500 can be configured to interact with one or more connected input/output or accessory device in providing the gaming experience. In some implementations, the computing device communicates with a handheld controller 550—e.g., a DualSense®, DualShock®, or Access™ controller for PlayStation® devices—to provide the gaming experience. The controller 550 can feature a high-fidelity haptic feedback system with one or more actuators that simulate a wide range of tactile sensations. In some implementations, the controller 550 includes one or more adaptive triggers that adjust resistance based on in-game actions to provide for a realistic feel.

The ergonomic design of the controller 550 can allow for comfortable use even in long gaming sessions. For example, the controller 550 can include textured grips and an optimized button layout. In some implementations, the controller 550 includes one or more of: integrated motion sensors, a high-resolution touchpad, and a built-in microphone array. The controller 550 includes an array of buttons, joysticks, and other controls that allow a user to interact with the computing device 500 to participate in interactive gameplay presented, for example, on a display device such as the display 516. The controller 550 can be powered by one or more regular or rechargeable batteries and supports both wireless and wired connectivity with the computing device 500, for example, via Bluetooth, WiFi, USB-C etc., or via a proprietary connection such as PlayStation Link™. In some implementations, the controller 550 includes a light bar and player indicators for visual feedback and customization.

In some implementations, the input/output or accessory device includes a VR/AR headset 552. One example of such a headset is the PlayStation VR2 (PS VR2) headset that is configured to provide an immersive and interactive gaming experience. In some implementations, the headset 552 features dual displays, e.g., organic light emitting device displays or micro-LED displays, with a combined resolution of 4000×2080 pixels or higher—thus providing sharp visuals and a wide field of view.

In some implementations, the VR/AR headset 552 includes eye-tracking technology that enables foveated rendering, by focusing on where the user is looking. In some implementations, the headset 552 includes integrated cameras that facilitate tracking head movements without external sensors. In some implementations, the headset includes haptic feedback for tactile sensations and/or one or more acoustic transducers configured to provide a spatial sound effect the user. The headset 552 can include an adjustable headband and cushioned padding and can be configured to connect to the computing device 500 either over a wireless network (e.g., over a WiFi® or Bluetooth® connection, or a proprietary connection such as PlayStation Link™) or over a wire such as a USB-C cable.

In some implementations, the headset 552 can be configured to work in conjunction with one or more accessory controllers 554 such as the PlayStation VR2 Sense™ controllers. The accessory controllers 554 can enhance the immersive gaming experience through various features such as advanced haptic feedback for detailed in-game sensations, adaptive triggers with dynamic resistance to simulate real-world actions, and finger touch detection for natural interactions. The ergonomics of the accessory controllers 554 can provide a comfortable experience even during extended gameplay. In some implementations, the accessory controllers include one or more integrated sensors (accelerometer, gyroscope, etc.) and/or cameras to provide motion tracking. The accessory controllers 554 can be configured to connect to the computing device 500 and/or the headset 552 over a wireless connection such as WiFi® or Bluetooth®.

In some implementations, the computing device 500 is connected to a handheld gaming device 556 such as the PlayStation Portal^{®}. The handheld gaming device 556 can be configured to stream games and media from the computing device 500 via a wireless connection such as WiFi® or Bluetooth®. The handheld gaming device 556 includes a high-resolution screen that allows users to play games and/or stream media remotely without using the display 516 connected to the computing device 500. This allows the display to be used for other purposes while the computing device 500 facilitates gameplay on the handheld gaming device 556. In some implementations, the handheld gaming device 556 is configured to act as a streaming receiver without running games natively on the device 556 itself. This makes the handheld gaming device 556 a convenient option for playing games run on the computing device 500, while leaving a TV connected to the computing device 500 free to be used for viewing other media. The handheld gaming device 556 can includes buttons and features similar to (or even same as) the controller 550, thus providing for a similar gaming experience as that with the controller 550.

In some implementations, the input/output or accessory devices includes a camera 558 and/or an earphone/headphone set 560 such as the PULSE Elite™ headset or the Pulse Explore™ earbuds. The camera 558 can be used to track user-movements, which in turn can be used as an input to an interactive game being executed on the computing device 500. The earphone/headphone set 560 can be used to provide audio feedback/output to a user from the computing device 500. In some implementations, the earphone/headphone set 560 can include a microphone to receive spoken inputs/instructions that in turn can be used to control an interactive game being executed on the computing device 500.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

While this specification contains many specific implementation details, these should not be construed as limitations on the scope of what is being claimed, which is defined by the claims themselves, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method comprising:
providing, by a host device and to a first client device in data communication with the host device through a first data communication channel, transmission data, the host device comprising a game console and the first client device comprising a peripheral device and including an embedded host wireless communication device, wherein the transmission data comprises (1) a first transmission data to cause operation of the first client device and (2) a second transmission data to cause the embedded host wireless communication device to perform operations comprising:
generating, by the embedded host wireless communication device and responsive to receiving the second transmission data, third transmission data between the embedded host wireless communication device and a plurality of second client devices in data communication with the embedded host wireless communication device; and
providing, by the embedded host wireless communication device and through a second data communication channel, the third transmission data to cause the operation of at least one of the plurality of second client devices, wherein a distance of transmission between the embedded host wireless communication device of the first client device and the at least one of the plurality of second client devices is less than a distance of transmission between the host device and the at least one of the plurality of second client devices, and wherein a degree of physical obstruction is less between the first client device and the at least one of the plurality of second client devices than between the host device and the at least one of the plurality of second client devices.

2. The method of claim 1, further comprising:
receiving, by the embedded host wireless communication device and from at least one of the plurality of second client devices using the second data communication channel, first received data; and
providing, by the embedded host wireless communication device and by the first client device and using the first data communication channel, the first received data and second received data from the first client device to the host device.

3. The method of claim 1, wherein providing the third transmission data by the embedded host wireless communication device comprises:
providing, by an antenna of the embedded host wireless communication device located within a housing of the first client device, the third transmission data to at least one of the plurality of second client devices.

4. The method of claim 3, wherein providing, by the antenna of the embedded host wireless communications device, the third transmission data comprises:
determining a type of device of a plurality of types of devices for the first client device;
determining antenna characteristics for the antenna in response to the type of device of the first client device; and
selecting, for the antenna characteristics and the type of device, transmission parameters for the third transmission.

5. The method of claim 4, wherein determining antenna characteristics for the antenna in response to the type of device of the first client device comprises: determining one or more of (i) antenna size, (ii) antenna location and orientation within the housing of the first client device, or (iii) transmission power.

6. The method of claim 4, wherein determining a type of device of the plurality of types of devices for the first client device further comprises:
determining one or more of (i) relative spatial orientations between the first client device and each of the plurality of second client devices, (ii) level of interference of data transmission between the first client device and each of the plurality of second client devices, or (iii) reliability requirement for data transmission between the first client device and each of the plurality of second client devices.

7. The method of claim 1, wherein providing, by the host device and to the first client device in data communication with the host device through the first data communication channel, transmission data comprises:
providing the transmission data using a wired data communication channel.

8. The method of claim 1, wherein providing, by the embedded host wireless communication device and to the at least one of the plurality of second client devices through the second data communication channel, the third transmission data comprises:
providing the third transmission data using a wireless data communication channel.

9. The method of claim 1, wherein providing, by the host device and to the first client device in data communication with the host device through the first data communication channel, transmission data comprises:
providing the transmission data from the host device to the first client device comprising one of a keyboard, monitor, or web camera, wherein the one of keyboard, monitor, or web camera includes the embedded host wireless communications device.

10. The method of claim 1, wherein providing the first transmission data to cause operation of the first client device comprises providing control signals to cause operation of a native application of the first client device.

11. The method of claim 1, wherein providing, by the embedded host wireless communication device and to the at least one of the plurality of second client devices through the second data communication channel, the third transmission data comprises:
providing third transmission data to two or more different second client devices.

12. The method of claim 1, wherein providing, by the embedded host wireless communication device and to the at least one of the plurality of second client devices through the second data communication channel, the third transmission data comprises:
providing, the third transmission data to wireless peripheral devices for gaming systems.

13. (canceled)

14. A system comprising:
a host device comprising a game console;
a first client device in data communication with the host device through a first data communication channel, the first client device comprising a peripheral device and including an embedded host wireless communication device within an enclosure of the first client device; and
a plurality of second client devices in data communication with the embedded host wireless communication device of the first client device through a second data communication channel,
wherein the host device comprises one or more processors in data communication with one or more memory and configured to perform operations comprising:
providing, by the host device and to the first client device through the first data communication channel, transmission data, wherein the transmission data comprises (1) a first transmission data to cause operation of the first client device and (2) a second transmission data to cause the embedded host wireless communication device perform operations comprising:
generating, by the embedded host wireless communication device and responsive to receiving the second transmission data, third transmission data between the embedded host wireless communication device and the plurality of second client devices in data communication with the embedded host wireless communication device; and
providing, by the embedded host wireless communication device and through the second data communication channel, the third transmission data to cause the operation of at least one of the plurality of second client devices, wherein a distance of transmission between the embedded host wireless communication device of the first client device and the at least one of the plurality of second client devices is less than a distance of transmission between the host device and the at least one of the plurality of second client devices, and wherein a degree of physical obstruction is less between the first client device and the at least one of the plurality of second client devices than between the host device and the at least one of the plurality of second client devices.

15. The system of claim 14, wherein the first client device comprises one of a keyboard, mouse, monitor, and web camera device.

16. (canceled)

17. The system of claim 14, wherein the embedded host wireless communication device within the enclosure of the first client device comprises:
one or more antenna in data communication with an antenna switch:
a radio configured to operate the antenna switch to transmit and receive data through a wireless data communication channel using the one or more antenna; and
one or more processors in data communication with one or more memory and in data communication with the radio and configured to perform the operations of:
providing the third transmission data to cause the operation of at least one of the plurality of second client devices; and
receiving, from at least one of the plurality of second client devices, a fourth transmission data.

18. An embedded host wireless communication device comprising:
one or more antenna in data communication with an antenna switch:
a radio configured to operate the antenna switch to transmit and receive data through a wireless data communication channel using the one or more antenna; and
one or more processors in data communication with one or more memory and in data communication with the radio, the one or more processors configured to perform operations comprising:
receiving, from a host device comprising a game console and to a first client device in data communication with the host device through a wired data communication channel, first transmission data, the first client device comprising a peripheral device and including the embedded host wireless communication device within an enclosure of the first client device, wherein the transmission data comprises (1) a first transmission data to cause operation of the first client device and (2) a second transmission data to cause the embedded host wireless communication device to perform operations comprising:
generating, by the one or more processors of the embedded host wireless communication device and responsive to receiving the second transmission data, third transmission data between the embedded host wireless communication device and a plurality of client devices in data communication with the embedded host wireless communication device; and
providing, by the one or more processors of the embedded host wireless communication device and through the wireless data communication channel, the third transmission data to cause the operation of at least a second client device of the plurality of client devices, wherein a distance of transmission between the embedded host wireless communication device of the first client device and the at least one of the plurality of second client devices is less than a distance of transmission between the host device and the at least one of the plurality of second client devices, and wherein a degree of physical obstruction is less between the first client device and the at least one of the plurality of second client devices than between the host device and the at least one of the plurality of second client devices.

19. The embedded host wireless communication device of claim 18, wherein the first client device comprises one of a keyboard, mouse, monitor, and web camera.

20. (canceled)

21. The embedded host wireless communication device of claim 18, wherein the antenna comprises a patch antenna.

22. The embedded host wireless communication device of claim 18, wherein the antenna comprises a directional antenna.

23. The embedded host wireless communication device of claim 18, wherein the operations of the embedded host wireless communication device further comprise:
receiving, by the one or more processors of the embedded host wireless communication device and through the wireless data communication channel, fourth transmission data from at least a second client device of the plurality of client devices; and
providing, by the one or more processors of the embedded host wireless communication device and through the wired data communication channel, the fourth transmission data to the host device.

24. The embedded host wireless communication device of claim 18, wherein a location and orientation of the antenna within the enclosure of the first client device is a first location and orientation for a first type of first client device and a second location and orientation for a second type of first client device.

25. The embedded host wireless communication device of claim 24, wherein the first type of first client device and the second type of first client device comprise one or more of (i) a different form factor of an enclosure of the first client device, (ii) an average distance of the first client device from a user of the first client device, and (iii) an average degree of obstruction of line-of-sight between the user and the first client device.

26. The embedded host wireless communication device of claim 24, wherein at least one of a size and a radio frequency (RF) power of the antenna within the enclosure of the first client device is a first size and a first RF power output for a first location of the first client device with respect to a user and a second size and a second RF power output for a second location of the first client device with respect to the user.
